(19) United States
(12) Patent Application Publication
(10) Pub. No.: US 2012/0162277 A1
(43) Pub. Date: Jun. 28, 2012

(54) DISPLAY AND DRIVING METHOD AND DISPLAYING METHOD THEREOF

(75) Inventors: Hsin-Nan Lin, New Taipei City (TW); Chi-Pao Huang, Taoyuan County (TW); Shih-Pin Chen, Taoyuan County (TW)

(73) Assignee: BENQ CORPORATION, Taipei (TW)

(21) Appl. No.: 13/214,282

(22) Filed: Aug. 22, 2011

(30) Foreign Application Priority Data
Dec. 24, 2010 (TW) 99145945

(51) Int. Cl. G09G 5/10; G09G 5/00

(52) U.S. Cl. 345/690; 345/204

(57) ABSTRACT

A display includes a display panel, a driver, a memory and a scaler. The driver is used for driving the display panel. The memory is used for storing multiple sets of preset modes. The scaler is electrically connected to the memory and the driver. When the scaler receives an image signal corresponding to at least two different applications, the scaler provides the different preset modes of the applications to non-overlapped display zones, which the applications located in, of a display frame, such that the driver can simultaneously drives at least two of the different preset modes on the display panel.

This application claims the benefit of Taiwan application Ser. No. 99145945, filed Dec. 24, 2010, the subject matter of which is incorporated herein by reference.

### BACKGROUND

1. Technical Field

The invention relates in general to a display and a driving method and a displaying method thereof, and more particularly to a human-based display and a driving method and a displaying method thereof.

2. Background

There are multiple applications providing the windows-splitting function on the market. Users can split windows with different sizes on the display by themselves, and display different contents on different windows at the same time. However, the displays for the time being can only display a single preset mode in the entire display frame. While the size of the display becomes larger and larger, if the users open multiple windows in the single display frame to operate multiple applications at the same time, the display having only one preset mode cannot provide different settings of multiple preset modes to operate in coordination with the windows with the different applications. Consequently, it causes inconvenience of the users.

For example, when the user utilizes two different applications located at non-overlapped display zones, one is showing a browser for goods shopping on the internet, and the other is showing the word editing application. If the display selectively applies the single standard mode to all of the display zones simultaneously, it may generate color errors of the goods in the browser. So that the user cannot view the accurate colors for goods shown in the browser, thus misleading shopping on the internet may occur.

### SUMMARY

The disclosure is directed to a display and a driving method and a displaying method thereof, capable of providing human-based high display quality frames to users by simultaneously driving at least two different preset modes on the display.

According to a first aspect of the present disclosure, a display is provided. The display includes a display panel, a driver, a memory and a scaler. The driver is used for driving the display panel. The memory is used for storing multiple sets of preset modes. The scaler is electrically connected to the memory and the driver. When the scaler receives an image signal corresponding to at least two different applications, the scaler provides the different preset modes of the applications to non-overlapped display zones, which the applications located in, of a display frame, such that the driver can simultaneously drive at least two of the different preset modes on the display panel.

According to a second aspect of the present disclosure, a driving method of a display, which stores multiple sets of preset modes in advance, is provided. The driving method includes the following steps. An image signal corresponding to at least two different applications is received. The different preset modes of the applications are provided to non-overlapped display zones, which the applications located in, of a display frame. At least two of the different preset modes are simultaneously driven on the display panel.

According to a third aspect of the present disclosure, a displaying method of a display, which stores multiple sets of preset modes, is provided. The displaying method includes the following steps. An image signal corresponding to at least two different applications, which respectively have different display characteristics, is received. A display frame of the display is split into multiple non-overlapped display zones, and number of the display zones is equal to number of the applications. The applications are individually assigned to locate in the display zones. The different preset modes are respectively read according to the display characteristics of the applications, and the preset modes are transmitted to the corresponding display zones, such that the display has at least two of the different preset modes on the display frame at the same time.

The invention will become apparent from the following detailed description of the preferred but non-limiting embodiments. The following description is made with reference to the accompanying drawings.

### BRIEF DESCRIPTION OF THE DRAWINGS

FIG. 1 shows a schematic illustration of a display according to an embodiment.

FIG. 2 shows a flow chart of a driving method of a display according to an embodiment.

FIG. 3 shows a schematic illustration of a display frame according to an embodiment.

FIG. 4 shows a flow chart of a displaying method of a display according to an embodiment.

FIG. 5 shows a simplified illustration of a look-up table according to an embodiment.

FIG. 6 shows a schematic illustration of an on-screen-display (OSD) menu providing different templates according to an embodiment.

### DETAILED DESCRIPTION OF THE INVENTION

The disclosure proposes a display and a driving method and a displaying method thereof, capable of providing human-based high display quality frames to users by simultaneously driving at least two different preset modes on the display.

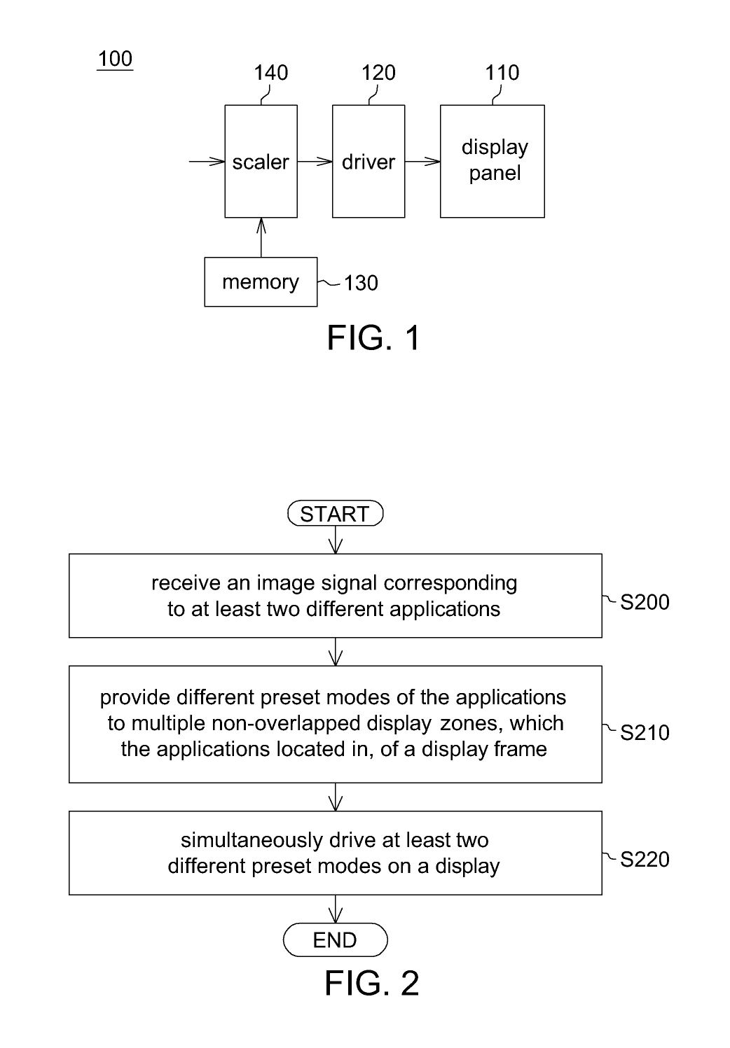

Referring to FIG. 1, a schematic illustration of a display according to an embodiment is shown. The display 100 includes a display panel 110, a driver 120, a memory 130 and a scaler 140. The driver 120 is used for driving the display panel 110. The driver 120 is, for example, a data driver or a scan driver, and is not limited thereto. The memory 130 is used for storing multiple sets of preset modes respectively corresponding to multiple applications. Each preset mode includes multiple parameters including contrast, brightness, sharpness, color temperature, saturation, gamma curve and color adjustment of the corresponding application. Magnitude of any one of the parameters in each preset mode is different from that in other preset modes. The scaler 140 is electrically connected to the memory 130 and the driver 120.

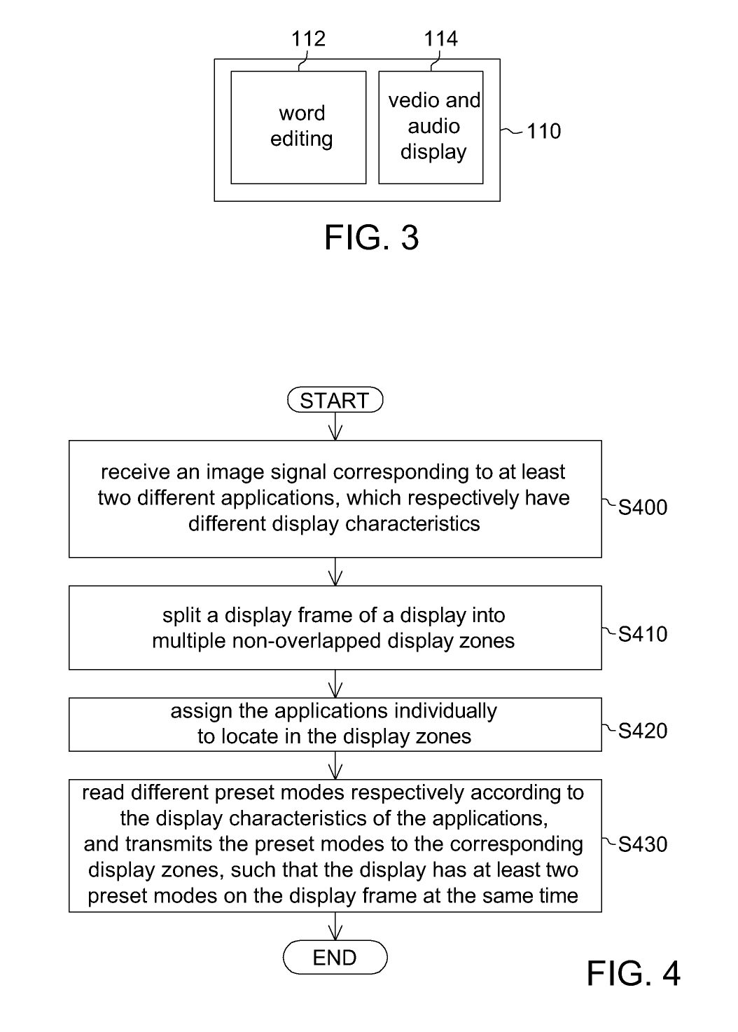

Referring concurrently now to FIGS. 2 and 3, FIG. 2 shows a flow chart of a driving method of a display according to an embodiment, and FIG. 3 shows a schematic illustration of a display frame according to an embodiment. In step S200, the scaler 140 receives an image signal corresponding to at least two different applications via a Display Data Channel Command Interface (DDC-CI) protocol. The image signal includes at least two preset mode identifiers and at least two sets of application displaying coordinates. Take the image signal correspond to a word editing application and a video and audio display application as being exemplified. Thus, the image signal includes a word editing mode identifier, a set of word editing displaying coordinates, a video and audio display mode identifier and a set of video and audio display displaying coordinates.

In step S210, the scaler 140 provides the different preset modes of the applications to non-overlapped display zones, which the applications located in, of a display frame of the display panel 110. Substantially, the scaler 140 reads the corresponding word editing preset mode and the corresponding video and audio display preset mode from the memory 130 respectively according to the word editing mode identifier and the video and audio display mode identifier, and then provides to the driver 120. In addition, the scaler 140 selects a corresponding display zone 112 on the display panel 110 according to the set of word editing displaying coordinates, and selects a corresponding display zone 114 on the display panel 110 according to the set of video and audio display displaying coordinates. The display zones 112 and 114 are non-overlapped.

Afterwards, in step S220, the driver 120 simultaneously drives the two different preset modes on the display 100. That is, the driver 120 is controlled by the scaler 140 to display the word editing application by driving the display zone 112 of the display panel 110 in the word editing preset mode; meanwhile, the driver 120 is also controlled by the scaler 140 to display video and audio display application by driving the display zone 114 of the display panel 110 in the video and audio display preset mode. Consequently, the users can enjoy the best display qualities corresponding to the respective applications in the different display zones 112 and 114.

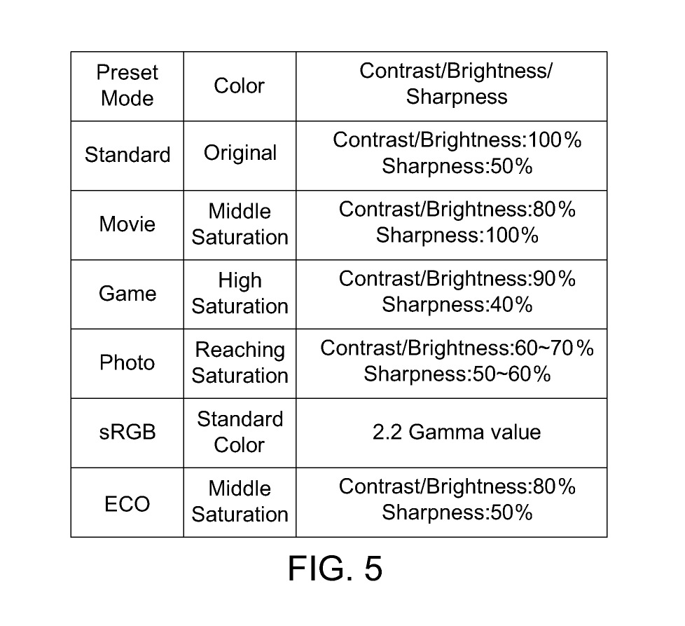

In addition, the disclosure also proposes a displaying method of a display. Referring to FIG. 4, a flow chart of a displaying method of a display according to an embodiment is shown. The display stores multiple sets of preset modes. Each preset mode includes multiple parameters of the preset modes including contrast, brightness, sharpness, color temperature, saturation, gamma curve and color adjustment. The parameters are stored in a memory of the display in a look-up table form for example. The look-up table may be a simplified illustration shown in FIG. 5, but it is not limited thereto.

First, in step S400, the display receives an image signal corresponding to at least two different applications, which respectively have different display characteristics. The display characteristics are such as a letter display characteristic, a web page display characteristic, an animation display characteristic, a game display characteristic, a standard color display characteristic, a picture display characteristic or an eco display characteristic. For the different display characteristics, the parameters of the preset modes, comprising contrast, brightness, sharpness, color temperature, saturation, gamma curve and color adjustment, are different.

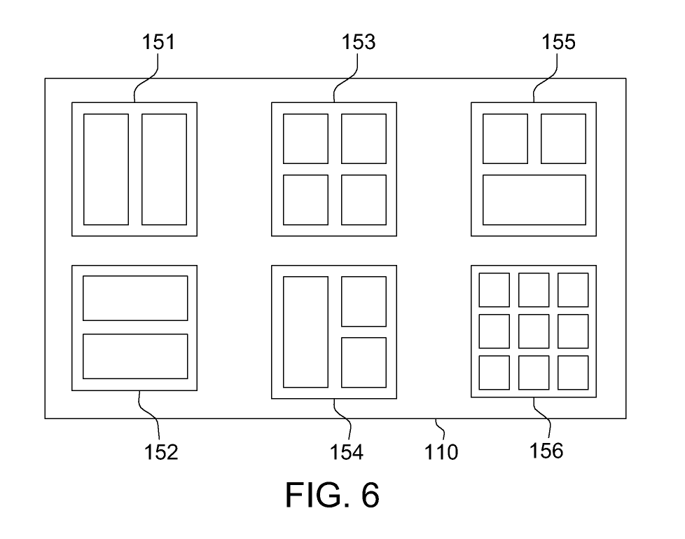

Next, in step S410, users can split a display frame of the display into multiple non-overlapped display zones, and number of the display zones is equal to number of the applications. The display stores multiple templates for splitting the display zones in advance. Referring to FIG. 6, a schematic illustration of an on-screen-display (OSD) menu providing different templates according to an embodiment is shown. In FIG. 6, the templates 151 to 156 on the OSD menu provided by the display panel 110 include different allocations and numbers of the display zones, and the templates 151 to 156 can be selected via the OSD menu of the display to be applied to the display, but it is not limited thereto. Then, in step S420, users can assign the applications individually to locate in the display zones according to the users' preference.

Afterwards, in step S430, the display reads the different preset modes respectively according to the display characteristics of the applications, and transmits the preset modes to the corresponding display zones, such that the display has at least two of the different preset modes on the display frame at the same time. In step S430, the display may utilize a scaler control circuit for outputting individual coordinates of the split display zones, and reading the corresponding preset modes according to the display characteristics of the individual display zones, hence the display may simultaneously display multiple applications on a screen in multiple preset modes.

The display and the driving method and the displaying method thereof proposed in the disclosure split a single display frame into different display zones for different applications, and apply different preset modes corresponding to the applications to the display zones. Therefore, it can simultaneously drive at least two different preset modes on the display, thus capable of providing human-based high display quality to users.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display, comprising:
a display panel;
a driver for driving the display panel;
a memory for storing a plurality of sets of preset modes; and
a scaler electrically connected to the memory and the driver;
wherein when the scaler receives an image signal corresponding to at least two different applications, the scaler provides the different preset modes of the applications to non-overlapped display zones, which the applications located in, of a display frame, such that the driver can simultaneously drive at least two of the different preset modes on the display panel.

2. The display according to claim 1, wherein the image signal includes at least two preset mode identifiers and at least two sets of application displaying coordinates, and the image signal is transmitted to the scaler via a Display Data Channel Command Interface (DDC-CI) protocol.

3. The display according to claim 1, wherein each preset mode comprises a plurality of parameters comprising contrast, brightness, sharpness, color temperature, saturation, gamma curve and color adjustment of the corresponding application.

4. A driving method of a display, which stores a plurality of sets of preset modes in advance, the driving method comprising:
receiving an image signal corresponding to at least two different applications;
providing the different preset modes of the applications to non-overlapped display zones, which the applications located in, of a display frame; and
driving at least two of the different preset modes simultaneously on the display panel.

5. The driving method of the display according to claim 4, wherein the image signal includes at least to preset mode identifiers and at least two sets of application displaying coordinates, and the image signal is transmitted to the display via a Display Data Channel Command Interface (DDC-CI) protocol.

6. The driving method of the display according to claim 4, wherein the display further comprises a scaler, and the scaler outputs the corresponding preset modes according to the display zones that the applications located in, each preset mode comprising a plurality of parameters comprising contrast, brightness, sharpness, color temperature, saturation, gamma curve and color adjustment of the corresponding application, magnitude of any one of the parameters in each preset mode different from that in other preset modes.

7. A displaying method of a display, which stores a plurality of sets of preset modes, the displaying method comprising:
receiving an image signal corresponding to at least two different applications, which respectively have different display characteristics;
splitting a display frame of the display into a plurality of non-overlapped display zones, number of the display zones being equal to number of the applications;
assigning the applications individually to locate in the display zones; and
reading the different preset modes respectively according to the display characteristics of the applications, and transmitting the preset modes to the corresponding display zones, such that the display has at least two of the different preset modes on the display frame at the same time.

8. The displaying method according to claim 7, wherein the display characteristics are a letter display characteristic, a web page display characteristic, an animation display characteristic, a game display characteristic, a standard color display characteristic, a picture display characteristic or an eco display characteristic, and parameters of the preset modes, comprising contrast, brightness, sharpness, color temperature, saturation, gamma curve and color adjustment, are different for the different display characteristics, the parameters stored in a memory of the display in a look-up table form.

9. The displaying method according to claim 8, wherein the display further comprises a scaler control circuit for outputting individual coordinates of the split display zones, and reading the corresponding preset modes according to the display characteristics of the individual display zones to simultaneously display the applications on the display.

10. The displaying method according to claim 7, wherein the display stores a plurality of templates for splitting the display zones, the templates comprising different allocations and numbers of the display zones and capable of being selected via an on-screen-display (OSD) menu of the display to be applied to the display.
